(19) United States
(12) Patent Application Publication
(10) Pub. No.: US 2022/0275748 A1
(43) Pub. Date: Sep. 1, 2022

(54) IGNITION PROMOTER ASSEMBLY AND ENGINE HAVING THE SAME

(71) Applicants: HYUNDAI MOTOR COMPANY, Seoul (KR); KIA MOTORS CORPORATION, Seoul (KR)

(72) Inventors: Mark SHIRLEY, Albion, MI (US); Philip ZOLDAK, Plymouth, MI (US); Mayuri WAGH, Farmington Hills, MI (US)

(73) Assignees: HYUNDAI MOTOR COMPANY, Seoul (KR); KIA MOTORS CORPORATION, Seoul (KR)

(21) Appl. No.: 17/187,491

(22) Filed: Feb. 26, 2021

(51) Int. Cl. F02B 19/18; F02B 19/12; F02M 61/14

(52) U.S. Cl. CPC F02B 19/18; F02B 19/12; F02M 61/14

(57) ABSTRACT

An ignition promoter assembly includes: an ignition device to ignite a mixture of fuel and air; and a passive pre-chamber body that defines: a cylindrical fitting space into which the ignition device is inserted, and a secondary combustion space along with an end of the inserted ignition device. In particular, the passive pre-chamber body fluidly communicates with a main combustion chamber disposed outside an exterior surface of the passive pre-chamber body through a flow channel, and the passive pre-chamber body includes: a cylindrical main body portion defining the cylindrical fitting space; and an end portion continuously extended from the cylindrical main body portion and at least partially exposed to the main combustion chamber. In particular, the flow channel is formed in the end portion of the passive pre-chamber body, and a volume of the cylindrical fitting space is greater than a volume of the secondary combustion space.

### FIELD

The present disclosure relates to an internal combustion engine having an ignition promoter assembly for a vehicle.

### BACKGROUND

The statements in this section merely provide background information related to the present disclosure and may not constitute prior art.

An internal combustion engine introduces fuel and air in a cylinder during an intake stroke, and a mixture of the fuel and air in a combustion chamber formed by the cylinder, a piston arranged in the cylinder and a cylinder head of the engine is compressed during a compression stroke and ignited by electrical discharge from a spark plug. The mixture of the air and fuel burns in the combustion chamber and thus expands against a movable piston that drives a crankshaft such that the engine generates driving power, and a vehicle may run with the driving power from the engine.

The internal combustion engine may include a pre-combustion chamber per cylinder for ignition purpose, in particular, for improving ignition in a lean mixture of fuel and air. For example, large-bore engines use those pre-chambers as it is otherwise difficult to consistently achieve complete and thorough combustion using lean fuel air mixtures.

Typically, such a pre-chamber is fluidly connected to a main combustion chamber of a respective cylinder via a riser channel and a plurality of flow transfer channels. The flow transfer channels and the riser channel allow the flow of the lean mixture of fuel and air from the main combustion chamber into the pre-chamber during a compression stroke.

Enrichment of the lean mixture in the pre-chamber may be achieved by providing a small quantity of fuel injected directly into the pre-chamber via a separate fuel feed passage, for example during the intake stroke. The enriched mixture is ignited in the pre-chamber by a spark plug that is also located inside the pre-chamber. The ignition of the enriched mixture causes a flame front of hot gases that propagates from the pre-chamber via the flow transfer channels into the main combustion chamber. Thus, the lean mixture in the main combustion chamber ignites and burns.

We have discovered that it is difficult for lean burn engines, which utilize lean fuel and air ratios, to consistently ignite the mixture in an internal combustion engine with and achieve complete and thorough combustion within the main combustion chamber because of the relatively slow rate of flame propagation.

### SUMMARY

The present disclosure relates to an internal combustion engine having an ignition promoter assembly for a vehicle. In one form of the present disclosure, an ignition promoter assembly for an engine comprises: an ignition device configured to ignite a mixture of fuel and air; and a passive pre-chamber body that defines a cylindrical fitting space into which the ignition device is inserted, and a secondary combustion space along with an end of the inserted ignition device. In particular, the passive pre-chamber body is configured to fluidly communicate with a main combustion chamber disposed outside an exterior surface of the passive pre-chamber body through at least one flow channel. In one form, the passive pre-chamber body includes: a cylindrical main body portion defining the cylindrical fitting space; and an end portion continuously extended from the cylindrical main body portion and at least partially exposed to the main combustion chamber. In particular, the end portion defines the secondary combustion space along with the end of the inserted ignition device, the at least one flow channel is formed in the end portion of the passive pre-chamber body, and a volume of the cylindrical fitting space is greater than a volume of the secondary combustion space.

In another form, at least one flow channel is aligned with a central region of the main combustion chamber, and during a compression stroke of the engine, a part of a mixture of fuel and air contained in the main combustion chamber is introduced into the secondary combustion space, and the ignition device ignites the introduced mixture of fuel and air in the secondary combustion space during an expansion stroke of the engine such that a high velocity turbulent flame is generated in the secondary combustion space and propagates from the second combustion space through the at least one flow channel into the main combustion chamber.

In other form, the at least one flow channel includes a plurality of flow channels, and flow channels of the plurality of flow channels are spaced apart each other.

In still another form, the at least one flow channel extends along a flow channel axis from an inner opening formed in an interior surface of the end portion and to an outer opening formed in the exterior surface of the end portion via a throat section.

In some forms, a cross-sectional area of the at least one flow channel converges from a first cross-sectional area of the inner opening to a second cross-sectional area of the throat section and diverges from the second cross-sectional area of the throat section to a third cross-sectional area of the outer opening.

In some forms, a cross-sectional area of the at least one flow channel may gradually decrease from the inner opening to the throat section, maintain a cross-sectional area of the throat section within a predetermined distance along the flow channel axis, and then gradually increase from the throat section to the outer opening such that the at least one flow channel forms a converge-straight-diverge shape.

In another aspect, the present disclosure provides an engine comprises: an engine block defining a cylinder; a cylinder head configured to cover the cylinder; a main combustion chamber defined at least partially by the cylinder of the engine block and the cylinder head; an ignition device configured to ignite a mixture of fuel and air; a piston reciprocally disposed within the cylinder and configured to compress the mixture of fuel and air during a compression stroke of the engine; a passive pre-chamber body disposed at least partially within the main combustion chamber; and an injector disposed outside of the passive pre-chamber body and configured to inject a fuel into the main combustion chamber during the compression stroke.

In particular, the passive pre-chamber body includes: a cylindrical main body portion defining a cylindrical fitting space; an end portion continuously extended from the cylindrical main body portion and at least partially exposed to the main combustion chamber; and at least one flow channel formed in the end portion of the passive pre-chamber body; and an injector disposed outside of the passive pre-chamber body and configured to inject a fuel into the main combustion chamber during the compression stroke. In one form, the ignition device is positioned in the cylindrical fitting space of the passive pre-chamber body, an end of the ignition device and the end portion of the passive pre-chamber body form a secondary combustion space, and the at least one flow channel is aligned with a central region of the main combustion chamber. During the compression stroke of the engine, a part of a central fuel-air mixture in the central region of the main combustion chamber which is richer than a fuel-air mixture in a remaining region of the main combustion chamber flows into the secondary combustion space through the at least one flow channel formed in the end portion of the passive pre-chamber body.

The locally rich mixture in the secondary combustion space is ignited by the ignition device such as a spark plug. Once ignited, sufficient energy is provided to ignite the lean mixture in the main combustion chamber by ejecting high velocity turbulent flame jets through the flow channel(s). This enables extension of the lean limit (e.g., lambda λ>=1.1) and helps to improve both fuel economy and emissions for light duty engines. However, it can also be used to improve the burn rate of stoichiometric and rich burn engines (λ<=1.0), which in turn helps to improve cycle to cycle variations and subsequent emissions. Here, the lambda λ is an air-fuel ratio(AFR)/stoichiometric AFR.

In one form, a cross-sectional area of the at least one flow channel converges from a first cross-sectional area of an inner opening formed in an interior surface of the end portion to a second cross-sectional area of a throat section and diverges from the second cross-sectional area of the throat section to a third cross-sectional area of an outer opening formed in an exterior surface of the end portion of the passive pre-chamber body.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a partial cross-sectional side view of an engine having an engine block defining a cylinder and a cylinder head covering the cylinder in one form of the present disclosure;

FIG. 2 is an enlarged partial cross-sectional side view illustrating a passive pre-chamber body inserted into a mounting hole formed in the cylinder head in FIG. 1;

FIG. 3 is a schematic view of a compression stroke of an engine in one form of the present disclosure;

FIG. 4A is a view of illustrating an ignition promoter assembly that includes an ignition device and a passive pre-chamber body in one form of the present disclosure;

FIG. 4B is an enlarged cross-sectional view of the passive pre-chamber body in FIG. 4A;

FIG. 5A is an enlarged view of an end portion of the passive pre-chamber body in FIG. 4A, and FIG. 5B shows a schematic illustration of different cross-sections of a flow channel along its length in one form of the present disclosure;

FIG. 6A is an enlarged view of an end portion of a passive pre-chamber body in another form of the present disclosure, and FIG. 6B shows a schematic illustration of different cross-sections of a flow channel along its length in FIG. 6A;

FIG. 6C illustrates a flow channel form in an end portion of a passive pre-chamber body in another form of the present disclosure;

FIG. 7A is a view of illustrating an ignition promoter assembly that includes an ignition device and a passive pre-chamber body in one form of the present disclosure, and FIGS. 7B and 7C respectively illustrate an arrangement of multiple flow channels formed in an end portion of a passive pre-chamber body in one form of the present disclosure;

FIG. 8 is a partial cross-sectional view of an ignition promoter assembly to show another form of an arrangement of flow channels according to one form of the present disclosure;

FIG. 9A is a schematic view of an expansion stroke of an engine in one form of the present disclosure;

FIGS. 9B and 9C illustrate a supersonic-jet flame and a compression shocks, respectively, during the expansion stroke in FIG. 9A;

FIG. 10A illustrates graphs showing a coefficient of variance of Indicated Mean Effective Pressure of a spark plug and other 3 passive pre-chamber body designs in some forms of the present disclosure; and

FIG. 10B shows graphs showing the comparison of the specific fuel consumption (“SFC”) when the spark plug and passive pre-chamber body are used according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

This present disclosure does not describe all components of forms, and general information in the technical field to which the present disclosure belongs or overlapping information between the forms will not be described.

It will be understood that, although the terms first, second, third, etc. may be used herein to describe various components, these components should not be limited by these terms. These terms are only used to distinguish one component from another.

Reference numerals used in operations are provided for convenience of description, without describing the order of the operations, and the operations can be executed in a different order from the stated order unless a specific order is definitely specified in the context.

Hereinafter, the operation principle and exemplary forms of the present disclosure will be described with reference to the accompanying drawings.

In one aspect, the present disclosure provides an engine having an ignition promoter assembly capable of improving ignitability of lean fuel-air mixtures using a passive pre-chamber body (alternatively, an unfueled pre-chamber body) forming a secondary combustion space in which a locally rich mixture flows in through a flow channel formed in the passive pre-chamber body during a compression stroke of the engine while a main combustion chamber contains generally lean mixtures.

The locally rich mixture in the secondary combustion space is ignited by an ignition device such as a spark plug. Once ignited, sufficient energy is provided to ignite the lean mixture in the main combustion chamber by high velocity turbulent flame jets exiting through the flow channel. This enables extension of the lean limit (e.g., air-fuel lambda λ>1.0) and helps to improve both fuel economy and emissions for light duty engines. And it can also be used to improve the burn rate at stoichiometric and rich conditions λ<=1.0

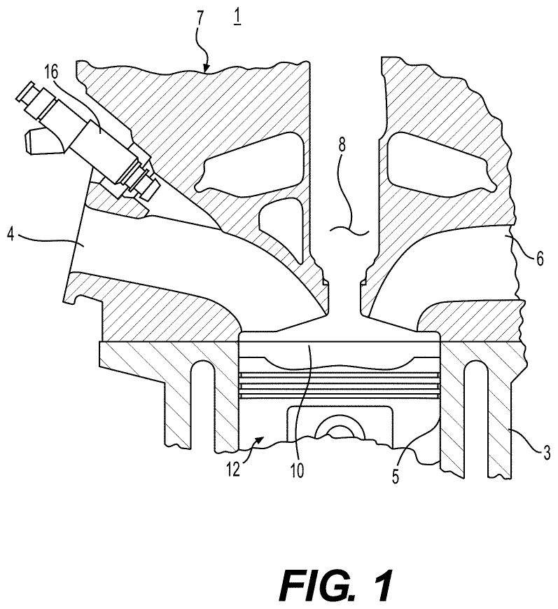

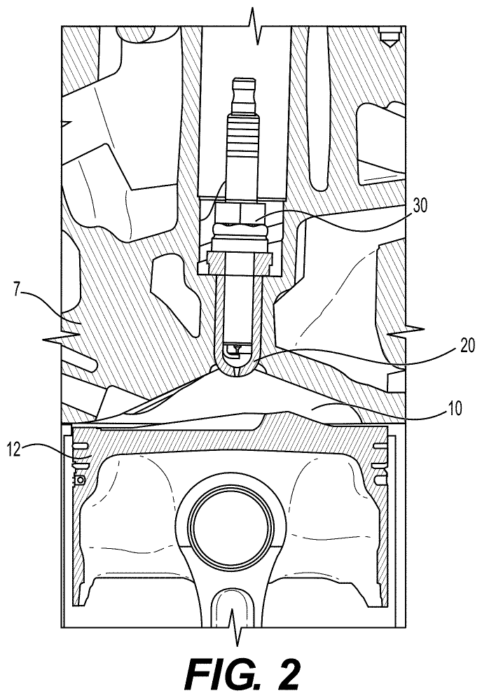

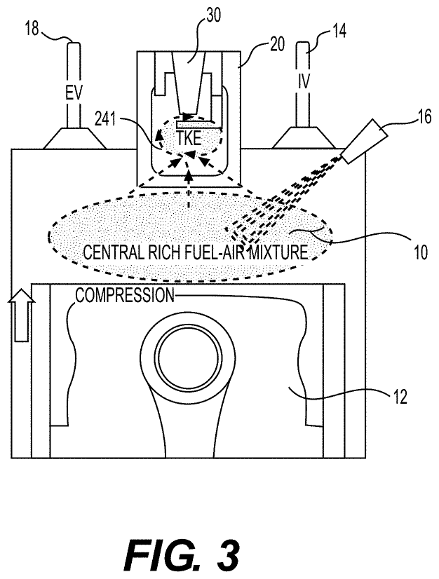

Referring now to the drawings to explain the general principle of the present disclosure by way of example, FIG. 1 illustrates a partial cross-sectional side view of an engine 1 that has an engine block 3 defining a cylinder 5, and a cylinder head 7 covering the cylinder 5 in one form of the present disclosure. FIG. 2 is an enlarged partial cross-sectional side view illustrating a passive pre-chamber body 20 inserted into a mounting hole 8 formed in the cylinder head in FIG. 1. FIG. 3 is a schematic view of a compression stroke of the engine in one form of the present disclosure.

FIGS. 1, 2 and 3 further depict the engine 1 including: an intake valve 14 disposed in an intake port 4; an exhaust valve 18 disposed in an exhaust port 6; a main combustion chamber 10 defined at least partially by the cylinder of the engine block and the cylinder head; an ignition device 30 (e.g., a spark plug) to ignite a mixture of fuel and air; a piston 12 that is reciprocally disposed within the cylinder 5 and moves between a top dead center (TDC) and a bottom dead center (BDC) during operation of the engine 1; and the passive pre-chamber body 20 disposed at least partially within the main combustion chamber 10.

For the purpose of describing exemplary forms of the present disclosure, the engine 1 is considered as a four-stroke engine operating at least partly on gaseous fuel such as a gaseous fuel engine or a dual fuel engine. One skilled in the art will appreciate, however, that the internal combustion engine may be any type of engine (turbine, gas, diesel, natural gas, propane, two-stroke, etc.) that would utilize the passive pre-chamber body as disclosed herein.

As illustrated in FIG. 3, during the compression stroke of the engine 1, the piston 12 moves upward to the TDC, and it compresses the mixture of fuel and air that have been induced into the cylinder via the intake port 4. In one form, an injector 16 may be disposed in the intake port 4 to inject fuel into the intake port 4 as shown in FIG. 1. In another form, the injector 16 may directly inject the fuel into the cylinder 5 (i.e., the main combustion chamber 10) in a gasoline direct injection (GDI) engine as illustrated in FIG. 3.

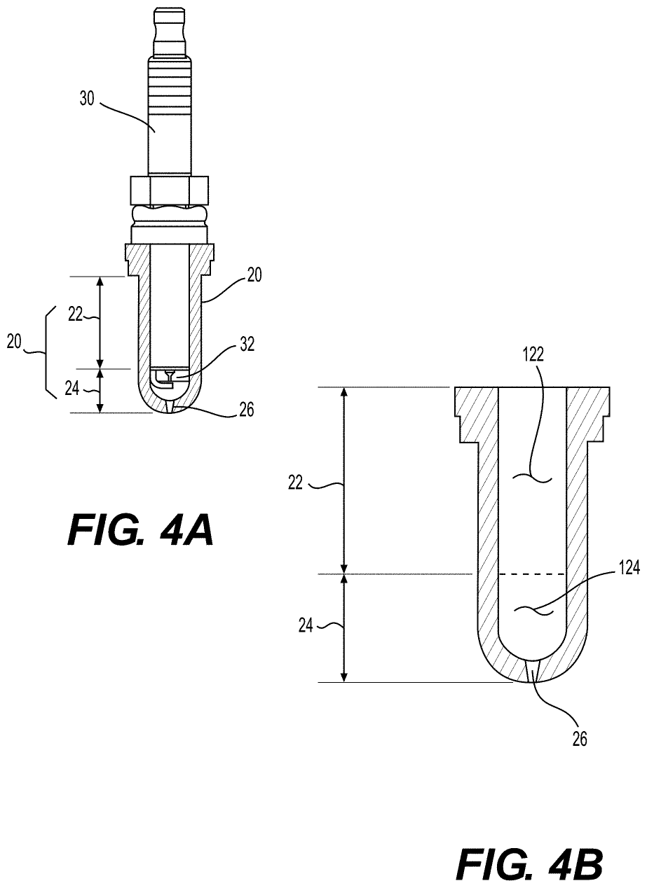

FIG. 4A is a view of illustrating an ignition promoter assembly that includes an ignition device and a passive pre-chamber body in one form of the present disclosure, and FIG. 4B is an enlarged cross-sectional view of the passive pre-chamber body in FIG. 4A.

Referring to FIGS. 2 and 4A-4B, the passive pre-chamber body 20 is inserted into the mounting hole 8 formed in the cylinder head 7 such that an end portion of the passive pre-chamber body 20 is exposed to the main combustion chamber 10. In some forms, the ignition device 30 is threaded or press-fitted into the passive pre-chamber body 20 in a manner that an end part of the ignition device 30 is spaced apart from a tip end of the end portion of the passive pre-chamber body 20.

The ignition promoter assembly includes the ignition device 30 such as a spark plug, and the passive pre-chamber body 20. For example, the spark plug may have threads machined off and be pressed into the pre-chamber body 20. Alternatively, the spark plug could be threaded into the pre-chamber body.

The structural arrangement of the passive pre-chamber body 20 and the ignition device 30 is illustrated in FIGS. 4A-4B. In one form, the passive pre-chamber body 20 includes a cylindrical main body portion 22 defining a cylindrical fitting space 122, and an end portion 24 that is continuously extended from the cylindrical main body portion 22. In particular, the end portion 24 is at least partially exposed to the main combustion chamber 10. As shown in FIGS. 4A-4B, the cylindrical main body portion 22 may be integrated with the end portion 24, forming a unitary body.

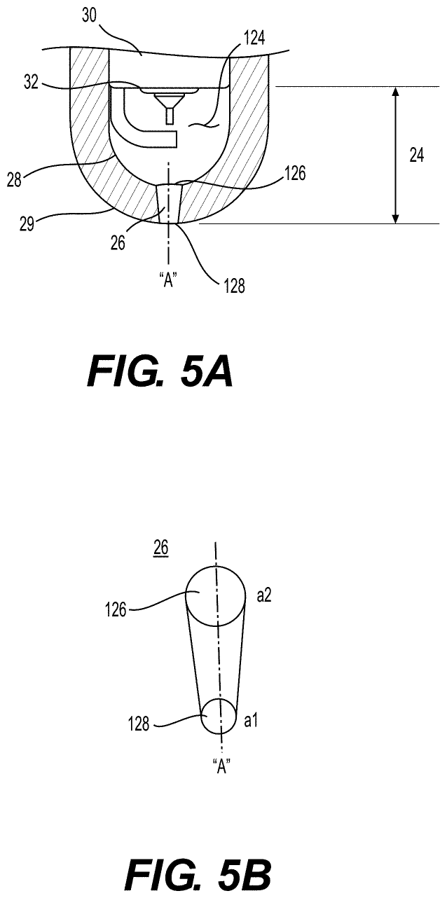

In particular, the ignition device 30 is inserted into the cylindrical fitting space 122 of the passive pre-chamber body using threads, press-fit or cast-in-place. When inserted, the end 32 of the ignition device 30 and the end portion 24 of the passive pre-chamber body 20 form a secondary combustion space 124 as shown in FIG. 4B and FIG. 5A. In one form, a volume of the cylindrical fitting space 122 is greater than a volume of the secondary combustion space 124.

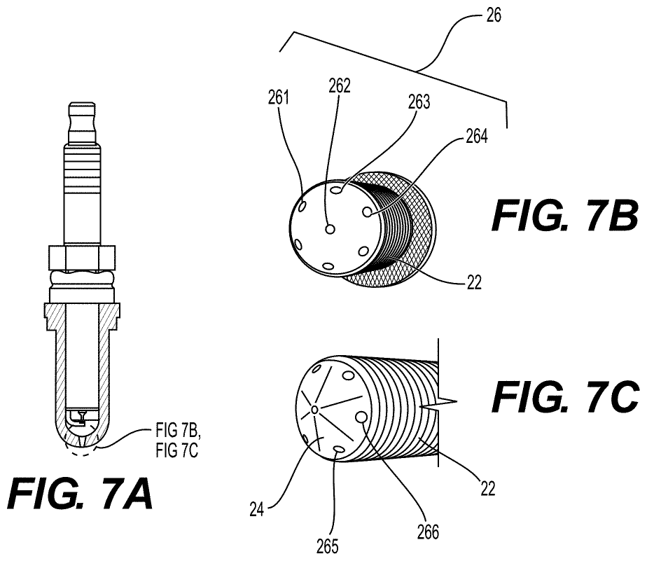

Referring to FIGS. 2 and 5A, the secondary combustion space 124 fluidly communicates with the main combustion chamber 10 via a flow channel 26 formed in the end portion 24 of the passive pre-chamber body 20. In one form, multiple flow channels 261, 262, 263, 264 may be formed in the end portion 24 of the of the passive pre-chamber body 20 and arranged to be space apart from each other as shown in FIG. 7B.

In some forms of the present disclosure, referring to FIGS. 5A-5B, the flow channel 26 is configured as a converging nozzle. Specifically, the flow channel 26 extends along a flow channel axis “A” and is converged from an inner opening 126 formed in an interior surface 28 of the end portion and to an outer opening 128 formed in an exterior surface 29 of the end portion 24 of the passive pre-chamber body 20.

FIG. 5B shows a schematic illustration of different cross-sections of the flow channel along its length (i.e., a flow channel axis “A”). In one form, a cross-sectional area “a2” of the inner opening 126 is greater than a cross-sectional area “a1” of the outer opening 128 as shown in FIG. 5B. In other words, the cross-sectional area of the flow channel 26 gradually decreases from the cross-sectional area “a2” of the inner opening 126 to the cross-sectional area “a1” of the outer opening 128 such that the flow channel 26 forms the converging nozzle shape along the flow channel axis “A”.

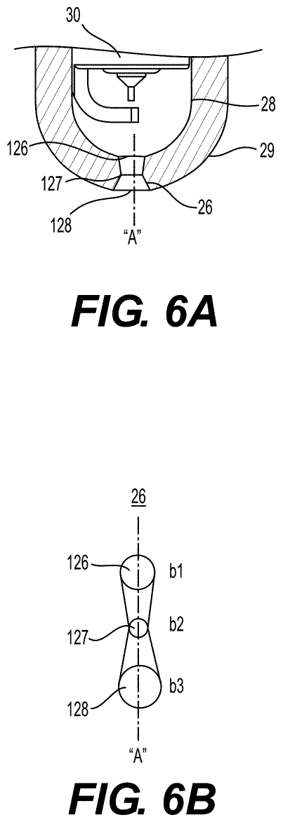

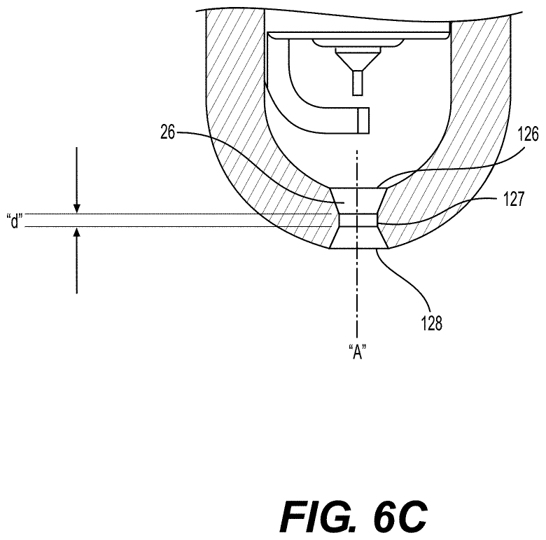

FIG. 6A is an enlarged view of the end portion of the passive pre-chamber body 20 in another form of the present disclosure, and FIG. 6B shows a schematic illustration of different cross-sections of the flow channel along the flow channel axis “A” in FIG. 6A

In another form, the flow channel 26 is configured as a converging-diverging nozzle as shown in FIGS. 6A-6B. Specifically, a cross-sectional area of the flow channel 26 converges from a cross-sectional area “b1” of the inner opening 126 to a cross-sectional area “b2” of a throat section 127 and diverges from the cross-sectional area “b2” of the throat section 127 to a cross-sectional area “b3” of the outer opening 128 along the flow channel axis “A”.

In still another form, the flow channel 26 may have the throat section that is extended a distance “d” while maintaining the same cross sectional area along the flow channel axis “A”. As illustrated in FIG. 6C, the cross-sectional area of the flow channel 26 gradually decreases from the inner opening 126 to the throat section 127, maintains the same cross-sectional area through the throat section within the predetermined distance “d” along the flow channel axis “A”, and then gradually increases from the throat section 127 to the outer opening 128 such that the flow channel forms a converge-straight-diverge shape.

FIGS. 7A-7C illustrate the arrangement of the multiple flow channels 26 (261, 262, 263, 264, 265, 266) as exemplary forms. The flow channels 261, 262, 263, 264, 265, 266 are formed in the end portion 24 of the passive pre-chamber body 20 and are space apart from each other. FIG. 8 is a partial cross-sectional view of the ignition promoter assembly to show another arrangement of the flow channels according to one form of the present disclosure. As shown in FIG. 8, flow channels axes (“A1,” “A2”) of a pair of flow channels among the multiple flow channels (261, 262, 263, 264, 265, 266) may form an angle “α.” The air fuel mixture in the main combustion chamber 10 travels through the flow channels into the secondary combustion space 124 during the compression stroke. The angle of these channels affect the flow field in the main chamber and enrichment of the secondary combustion space 124. The “α” angle is designed to have enriched fuel air mixture inside the secondary combustion space 124 for better performance.

Due to the flow channel(s) 26 (261, 262, 263, 264, 265, 266), during the compression stroke of the engine 1, a part of a mixture of fuel and air contained in the main combustion chamber 10 flows into the secondary combustion space 124 through the flow channel(s) 26 (261, 262, 263, 264, 265, 266) formed in the end portion 24 of the passive pre-chamber body 20. Since the passive pre-chamber body 20 does not accommodate or include any fuel injector and instead receives a part of the mixture of fuel and air contained in the main combustion chamber 10 during the compression stroke of the engine, it is called as “the passive” pre-chamber body 20, or “unfueled” pre-chamber body.

As briefly discussed above with FIG. 3, during the compression stroke of the engine 1, the piston 12 moves upward to the TDC and compresses the mixture of fuel and air contained in the main combustion chamber 10. During the compression, a part of the mixture in the main combustion chamber 10 flows into the secondary combustion space 124 through the flow channels 26 (261, 262, 263, 264, 265, 266) formed in the end portion 24 of the passive pre-chamber body 20.

In one form, the injector 16 is disposed outside of the passive pre-chamber body 20 and injects a fuel into the main combustion chamber 10 during the compression stroke of the engine 1. The injected fuel by the injector forms a central rich fuel-air mixture in a central region of the main combustion chamber 10. The central fuel-air mixture refers to a locally rich fuel-air mixture which is richer than a fuel-air mixture in a remaining region of the main combustion chamber 10. In the central region, the Lambda (λ) value is in the range of 0.7 and 1.0 (i.e., 0.7>Lambda (λ)>stoichiometric 1.0).

As shown in FIG. 3, when the fuel is injected into the main combustion chamber 10, such a locally rich fuel-air mixture is formed in the central region of the main combustion chamber 10, and the flow channel(s) 26 (261, 262, 263, 264, 265, 266) is aligned with the central region to allow a part of the central fuel-air mixture in the central region of the main combustion chamber to flow into the secondary combustion space 124 during the compression stroke.

In one form, the injector 16 is a direct injector that directly supplies fuel into the cylinder to create a stratified central rich fuel spray pattern (i.e., locally rich: 0.7>Lambda (λ)>stoichiometric 1.0) although the rest of the fuel air mixture in-cylinder is considered lean or in other words globally dilute.

During the compression stroke of the engine, the locally rich air and fuel mixture is compressed into the secondary combustion space 124 of the passive pre-chamber body 20 through the flow channels 26 (261, 262, 263, 264, 265, 266) such that a high turbulence kinetic energy (“TKE”) mixing field is created in the secondary combustion space 124 (See, FIG. 3). The rich mixture inside the secondary combustion space is affected by various factors such as: injection timing, a lambda value in the main combustion chamber 10, and turbulence in the main combustion chamber 10. For example, since the air-fuel mixture follows a tumble flow in the main combustion chamber 10, simulation results show that the mixture with a high velocity flow has a rich lambda value. During compression stroke, this rich mixture is induced near a spark gap of 0.75 mm in the secondary combustion space. The introduced mixture in the secondary combustion space 241 is ignited by a spark of the spark plug 30 during an expansion stroke of the engine.

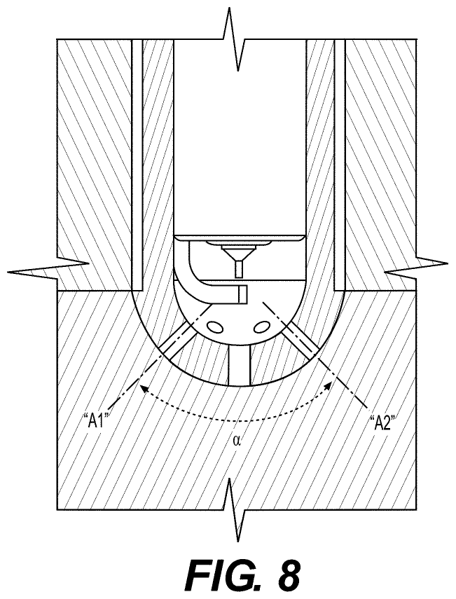

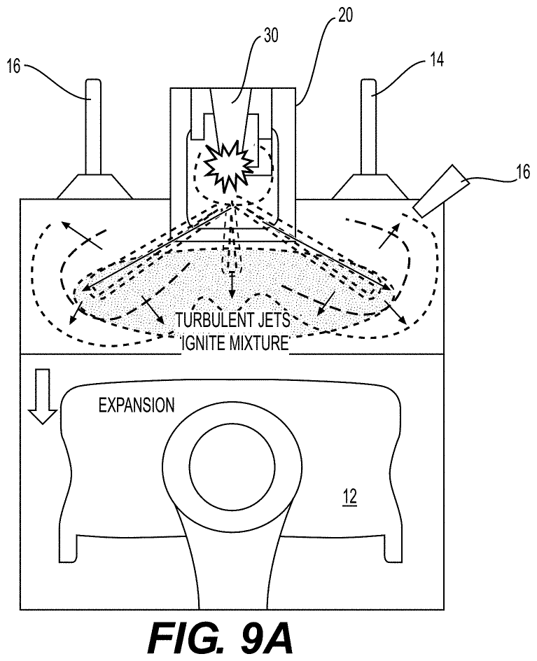

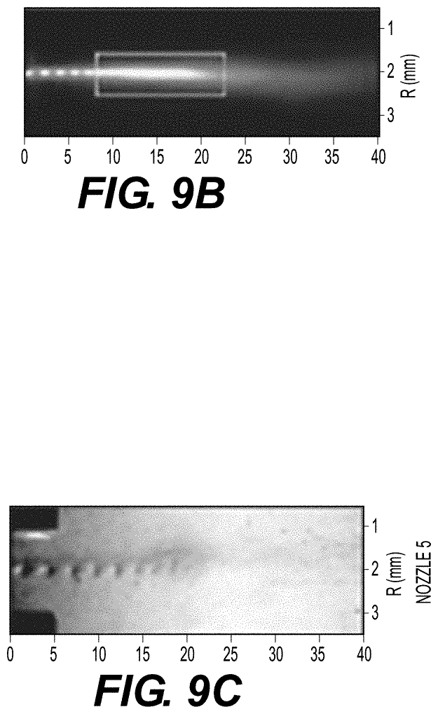

FIG. 9A is a schematic view of the expansion stroke of the engine in one form of the present disclosure. Referring to FIGS. 9A, 9B and 9C, when the spark plug 30 ignites the rich mixture in the secondary combustion space 241, a high velocity turbulent flame is generated in the secondary combustion space 241 and propagates from the secondary combustion space through the flow channel(s) 26 (261, 262, 263, 264, 265, 266) into the main combustion chamber 10. Due to the specified geometric configuration of the flow channel(s) 26 (261, 262, 263, 264, 265, 266) as disclosed above, the high velocity turbulent flame having exited the flow channel generates a supersonic jet flame in the main combustion chamber 10 as illustrated in FIGS. 9A-9B, and undergoes a partial quench to extend a lift-off length of the generated supersonic jet flame. Since the supersonic jet flames through the flow channel(s) undergo the partial quenching and is followed by downstream recompression, subsequent auto-ignition occurs in downstream. This helps to enhance the ignition of the lean mixture in the main combustion chamber 10.

In more detail, the high TKE in the secondary combustion space causes quick flame propagation in the secondary combustion space 241 when the spark of the spark plug 30 ignites the mixture in the secondary combustion space and rapidly build a high pressure in the secondary combustion space 241. Thus, the pressure of the flame exiting the flow channel 26 having the specific shape such as the converging-diverging shape is higher than a pressure in the main combustion chamber 10 and thus the flame flow continues to expand upon leaving the flow channel as a result of the pressure difference, and is considered in physical term an under-expanded flow (aka supersonic flow).

Furthermore, the high velocity turbulent flame jets exit the converging-diverging flow channel(s) 26 (see, FIGS. 6A-6C) and undergo a partial quench to extend a lift-off length. The shape of the converging-diverging flow channel 26 is designed to increase a pressure-ratio and an expansion-ratio, and thus nozzle jet flow exiting the converging-diverging flow channel(s) 26 can enter a supersonic regime and have extended lift off-length. The supersonic flame jets undergo regions of relative compression and expansion zones. The compressions zones can be hot enough such that they act as auto-ignition points. The supersonic jets provide a high energy stable ignition source for charge in the main combustion chamber 10 and lead flame propagation. Multiple ignition sources result inside the main chamber, thus sub-dividing the distance the flame must travel further enhancing burn rate. FIG. 9B illustrates the velocity (Mach number) along jet length. The static pressure of air-fuel mixture exiting the flow channel (e.g., nozzle) is much higher than combustion chamber pressure and shock diamonds are visible due to sudden change in pressure, density during the turbulent jet ignition event. FIG. 9C illustrates pressure waves along jet length, compression shocks of the supersonic flame jets.

As described above, the engine having the passive pre-chamber body or the ignition promoter assembly in the exemplary forms of the present disclosure device improves ignitability in lean fuel-air mixture and thus can improve fuel economy at various operating points via lean limit extension. In addition, the extended lean burn operation regions of the engine contribute to improving emission controls.

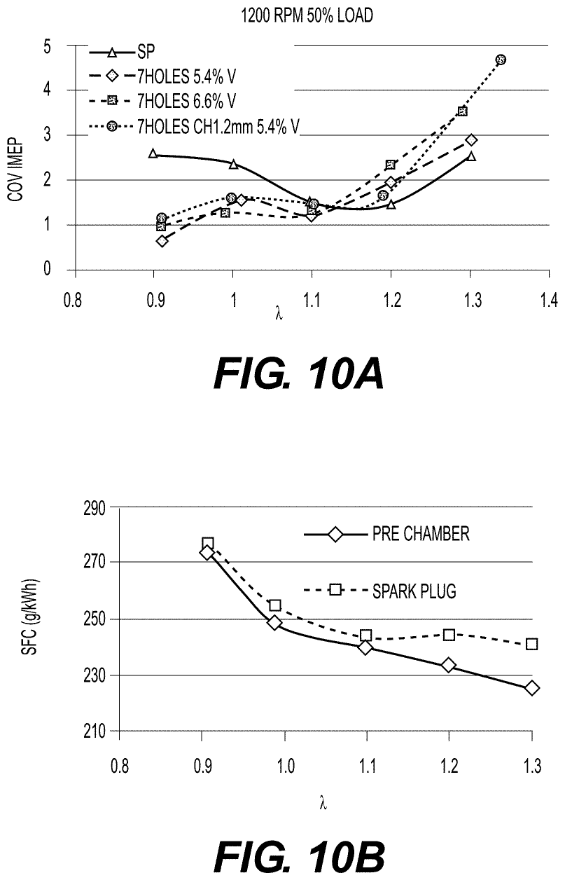

FIG. 10A is graphs illustrating a coefficient of variance of Indicated Mean Effective Pressure of a spark plug and other 3 passive pre-chamber body designs at 1200 RPM and 50% load condition. For example, the “7 Holes CH1.2 mm 5.4% V” passive pre-chamber body has seven flow channels, 1.2 mm diameter-center hole, and 5.4% volume of total volume. In FIGS. 10A-10B, “cov” stands for “Coefficient of variance,” “IMEP” means “Indicated Mean effective pressure,” and “BSFC” stands for “brake specific fuel consumption.” The cov of IMEP defines the cyclic variability in indicated work per cycle. As shown in FIG. 10A, the pre chamber (i.e., the secondary combustion space) has shown better covIMEP or combustion stability compared with spark plug at lean lambda conditions. FIG. 10B shows graphs to compare the brake specific fuel consumption (“BSFC”) when the spark plug and passive pre-chamber body are used. In particular, the passive pre-chamber shows the benefit of fuel economy gains as the lambda (λ) gets leaner.

Although a few forms of the present disclosure have been shown and described above, it would be appreciated by those skilled in the art that changes may be made in these forms without departing from the principles and spirit of the disclosure.

What is claimed is:

1. An engine comprising:
an engine block defining a cylinder;
a cylinder head configured to cover the cylinder;
a main combustion chamber defined at least partially by the cylinder of the engine block and the cylinder head;
an ignition device configured to ignite a mixture of fuel and air;
a piston reciprocally disposed within the cylinder and configured to move upward to compress the mixture of fuel and air during a compression stroke of the engine; and
a passive pre-chamber body disposed at least partially within the main combustion chamber, comprising:
a cylindrical main body portion defining a cylindrical fitting space;
an end portion continuously extended from the cylindrical main body portion and at least partially exposed to the main combustion chamber; and
at least one flow channel formed in the end portion of the passive pre-chamber body,
wherein:
the ignition device is positioned in the cylindrical fitting space of the passive pre-chamber body,
an end of the ignition device and the end portion of the passive pre-chamber body form a secondary combustion space,
during the compression stroke of the engine, a part of a mixture of fuel and air contained in the main combustion chamber flows into the secondary combustion space through the at least one flow channel formed in the end portion of the passive pre-chamber body, and
a volume of the cylindrical fitting space is greater than a volume of the secondary combustion space.

2. The engine of claim 1, further comprising: an injector disposed outside of the passive pre-chamber body and configured to inject a fuel into the main combustion chamber during the compression stroke,
wherein the injected fuel by the injector forms a central fuel-air mixture in a central region of the main combustion chamber which is richer than a fuel-air mixture in a remaining region of the main combustion chamber.

3. The engine of claim 2, wherein:
the at least one flow channel is aligned with the central region of the main combustion chamber, and
the part of the mixture of fuel and air introduced into the secondary combustion space is a part of the central fuel-air mixture richer than the fuel-air mixture in the remaining region of the main combustion chamber.

4. The engine of claim 3, wherein:
the part of the mixture of fuel and air introduced into the secondary combustion space is compressed during the compression stroke and ignited by the ignition device such that a high velocity turbulent flame is generated in the secondary combustion space and propagates from the secondary combustion space through the at least one flow channel into the main combustion chamber.

5. The engine of claim 4, wherein:
the high velocity turbulent flame having exited the at least one flow channel is configured to generate a supersonic jet flame in the main combustion chamber and undergo a partial quench to extend a lift-off length of the generated supersonic jet flame.

6. The engine of claim 3, wherein:
the at least one flow channel includes a plurality of flow channels, and
flow channels of the plurality of flow channels are spaced apart each other.

7. The engine of claim 2, wherein:
the at least one flow channel extends along a flow channel axis from an inner opening formed in an interior surface of the end portion and to an outer opening formed in an exterior surface of the end portion.

8. The engine of claim 7, wherein
a first cross-sectional area of the inner opening is greater than a second cross-sectional area of the outer opening.

9. The engine of claim 8, wherein
a cross-sectional area of the at least one flow channel converges from the first cross-sectional area of the inner opening to the second cross-sectional area of the outer opening.

10. The engine of claim 7, wherein
a cross-sectional area of the at least one flow channel converges from a first cross-sectional area of the inner opening to a second cross-sectional area of a throat section and diverges from the second cross-sectional area of the throat section to a third cross-sectional area of the outer opening.

11. The engine of claim 7, wherein
a cross-sectional area of the at least one flow channel gradually decreases from the inner opening to a throat section, maintains a cross-sectional area of the throat section within a predetermined distance along the flow channel axis, and gradually increases from the throat section to the outer opening such that the at least one flow channel forms a converge-straight-diverge shape.

12. An ignition promoter assembly for an engine, the ignition promoter assembly comprising:
an ignition device configured to ignite a mixture of fuel and air; and
a passive pre-chamber body defining: a cylindrical fitting space into which the ignition device is inserted, and a secondary combustion space along with an end of the inserted ignition device, wherein the passive pre-chamber body is configured to fluidly communicate with a main combustion chamber disposed outside an exterior surface of the passive pre-chamber body through at least one flow channel,
wherein the passive pre-chamber body includes:
a cylindrical main body portion defining the cylindrical fitting space; and
an end portion continuously extended from the cylindrical main body portion and at least partially exposed to the main combustion chamber, and
wherein:
the end portion defines the secondary combustion space along with the end of the inserted ignition device,
the at least one flow channel is formed in the end portion of the passive pre-chamber body, and
a volume of the cylindrical fitting space is greater than a volume of the secondary combustion space.

13. The ignition promoter assembly of claim 12, wherein:
the at least one flow channel is aligned with a central region of the main combustion chamber, and
during a compression stroke of the engine, a part of a mixture of fuel and air contained in the main combustion chamber is introduced into the secondary combustion space, and
the ignition device is configured to ignite the introduced mixture of fuel and air in the secondary combustion space during an expansion stroke of the engine such that a high velocity turbulent flame is generated in the secondary combustion space and propagates from the second combustion space through the at least one flow channel into the main combustion chamber.

14. The ignition promoter assembly of claim 13, wherein:
the at least one flow channel includes a plurality of flow channels, and
flow channels of the plurality of flow channels are spaced apart each other.

15. The ignition promoter assembly of claim 13, wherein:
the at least one flow channel extends along a flow channel axis from an inner opening formed in an interior surface of the end portion and to an outer opening formed in the exterior surface of the end portion via a throat section.

16. The ignition promoter assembly of claim 15, wherein: a first cross-sectional area of the inner opening is greater than a second cross-sectional area of the outer opening.

17. The ignition promoter assembly of claim 16, wherein a cross-sectional area of the at least one flow channel converges from the first cross-sectional area of the inner opening to the second cross-sectional area of the outer opening.

18. The ignition promoter assembly of claim 15, wherein a cross-sectional area of the at least one flow channel converges from a first cross-sectional area of the inner opening to a second cross-sectional area of the throat section and diverges from the second cross-sectional area of the throat section to a third cross-sectional area of the outer opening.

19. The ignition promoter assembly of claim 15, wherein a cross-sectional area of the at least one flow channel gradually decreases from the inner opening to the throat section, maintains a cross-sectional area of the throat section within a predetermined distance along the flow channel axis, and gradually increases from the throat section to the outer opening such that the at least one flow channel forms a converge-straight-diverge shape.

20. An engine comprising:
an engine block defining a cylinder;
a cylinder head configured to cover the cylinder;
a main combustion chamber defined at least partially by the cylinder of the engine block and the cylinder head;
an ignition device configured to ignite a mixture of fuel and air;
a piston reciprocally disposed within the cylinder and configured to compress the mixture of fuel and air during a compression stroke of the engine;
a passive pre-chamber body disposed at least partially within the main combustion chamber, the passive pre-chamber body comprising:
a cylindrical main body portion defining a cylindrical fitting space;
an end portion continuously extended from the cylindrical main body portion and at least partially exposed to the main combustion chamber; and
at least one flow channel formed in the end portion of the passive pre-chamber body; and
an injector disposed outside of the passive pre-chamber body and configured to inject a fuel into the main combustion chamber during the compression stroke,
wherein:
the ignition device is positioned in the cylindrical fitting space of the passive pre-chamber body,
an end of the ignition device and the end portion of the passive pre-chamber body form a secondary combustion space,
the at least one flow channel is aligned with a central region of the main combustion chamber,
during the compression stroke of the engine, a part of a central fuel-air mixture in the central region of the main combustion chamber which is richer than a fuel-air mixture in a remaining region of the main combustion chamber flows into the secondary combustion space through the at least one flow channel formed in the end portion of the passive pre-chamber body, and
a cross-sectional area of the at least one flow channel converges from a first cross-sectional area of an inner opening formed in an interior surface of the end portion to a second cross-sectional area of a throat section and diverges from the second cross-sectional area of the throat section to a third cross-sectional area of an outer opening formed in an exterior surface of the end portion of the passive pre-chamber body.
